(19) United States
(12) Patent Application Publication
(10) Pub. No.: US 2004/0019986 A1
(43) Pub. Date: Feb. 5, 2004

(54) Flexible contact cleaning roller

(76) Inventors: Frank C. Corrado, Rochester, NY (US); James W. Fischer, Rochester, NY (US); Gary R. Larsen, Webster, NY (US); Ronald W. Sweet, Conesus, NY (US)

Correspondence Address: Robert C. Brown, 1207 Sandhurst Drive, Tallahassee, FL, 32312, US

(21) Appl. No.: 10/210,125

(22) Filed: Aug. 1, 2002

(51) Int. Cl. B08B 1/02

(52) U.S. Cl. 15/3; 15/102; 15/104.002

(57) ABSTRACT

A contact cleaning roller which may be axially flexed to conform to a non-planar substrate surface for removing particles therefrom. In a preferred embodiment, a flexible shaft is covered with a high-tack sleeve comprising polyurethane, silicone, adhesive tape, or any other similar high-tack material. The shaft is rotatably suspended at either end in bearings in a frame, allowing the roller to conform to a non-planar substrate surface requiring cleaning, for example, a cathode ray tube screen.

### DESCRIPTION

The present invention relates to apparatus for cleaning particulate contamination from the surfaces of substrates; more particularly to cleaning apparatus having a particle-attracting (“contact cleaning”) roller for transferring particulate contamination from a substrate surface to the surface of the roller; and most particularly, to such apparatus wherein the contact cleaning roller is axially flexible and is especially suited to cleaning particles from non-planar substrate surfaces.

It is well known to convey a web substrate around a cylindrical particle-attracting roller to cause particulate contaminants on the surface of the web substrate to be transferred to the surface of the roller, thereby cleaning the web substrate surface. Such rollers are known in the art as “contact cleaning rollers” (CCR's), and may be provided with a tacky surface comprising, for example, adhesive tape as disclosed in U.S. Pat. No. 4,009,047, or an electrostatically-active polymeric surface, for example, a polyurethane as disclosed in U.S. Pat. Nos. 5,611,281 and 5,699,738, or a silicone, which patents are herein incorporated by reference.

Contact cleaning rollers in accordance with the prior art are suitable for cleaning surfaces of only planar substrates, such as plastic or other webs supported on rollers, or rigid sheet stock such as circuit boards. Slight surface irregularities may be accommodated in some applications by the compressibility of the polymeric sleeve, but more highly curved or non-planar surfaces cannot be cleaned readily by such rollers.

It is a principal object of the invention to provide improved contact cleaning apparatus which can clean particles from non-planar substrate surfaces.

Briefly described, a flexible contact cleaning roller in accordance with the invention is a flexible cylinder having an axis of rotation. The roller is formed of such material and in such a way as to permit the cylindrical shape to be deformed axially in response to radial force exerted on a surface of the roller as the roller is rolled along a substrate surface to be cleaned. Such forces may be applied randomly or non-randomly when such a roller is rolled along a non-planar surface. Such deformation permits the cleaning surface of the roller to remain in contact with the non-planar surface over the entire length of the roller as it is rolled along the surface to remove particles therefrom.

Preferably, the roller comprises a flexible core, also referred to herein interchangeably as a shaft or mandrel, which may be formed of a flexible polymer, for example, nylon, or a flexible metal or other fatigue-resistant material, the core terminating in ends suitable for retention in sleeve or roller bearings at opposite ends thereof. A sleeve of high-tack material is formed over the core or mandrel, defining a tacky outer cleaning surface for removing particles from surfaces with which the cleaning surface comes into contact.

Alternatively, the roller may comprise a substantially monolithic flexible cylinder having a high-tack surface and may be fitted at the ends thereof with suitable mounting apparatus such as retaining cups, stub shafts, or other known means for rotatably coupling a roller to a frame.

In operation for cleaning, either the frame is advanced towards the surface to be cleaned or the surface is advanced towards the frame, such that the roller is fully engaged with the surface, preferably across the entire length of the roller. The surface then may be rollably moved past the roller when stationary, or the surface may remain stationary and the frame may be moved to translate the roller rollably over the stationary surface, the roller surface conforming to non-planarities in the substrate surface.

A flexible contact cleaning roller in accordance with the invention may be readily incorporated into cleaning apparatus and uses already well known in the art, for example, multiple-roller arrangements having pivoting or turreted frames; stationary or roller-oscillating systems; secondary cleaning rollers for cleaning particles from the flexible cleaning roller; and other forms of flexible roller cleaning stations. Such a roller is suitable for cleaning both planar and non-planar surfaces.

The foregoing and other objects, features, and advantages of the invention, as well as presently preferred embodiments thereof, will become more apparent from a reading of the following description in connection with the accompanying drawings in which:

FIG. 1 is an elevational cross-sectional view of a first embodiment of a flexible contact cleaning roller in accordance with the invention;

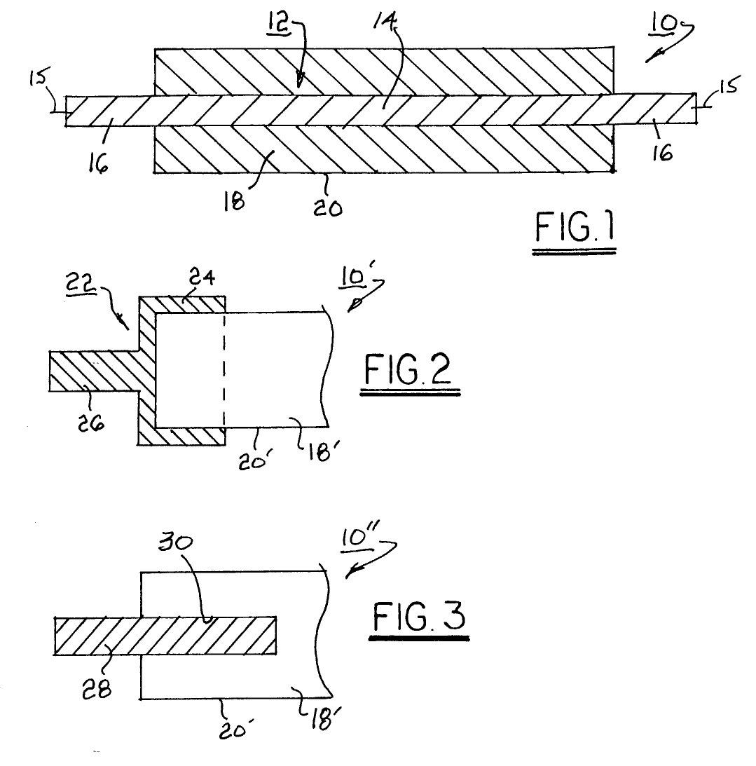

FIG. 2 is an elevational cross-sectional view of a second embodiment, showing a monolithic roller element supported for rotatable mounting by a cup-shaped receiver;

FIG. 3 is an elevational cross-sectional view of a third embodiment, showing a monolithic roller element having a cast or inserted stub shaft for rotatable mounting;

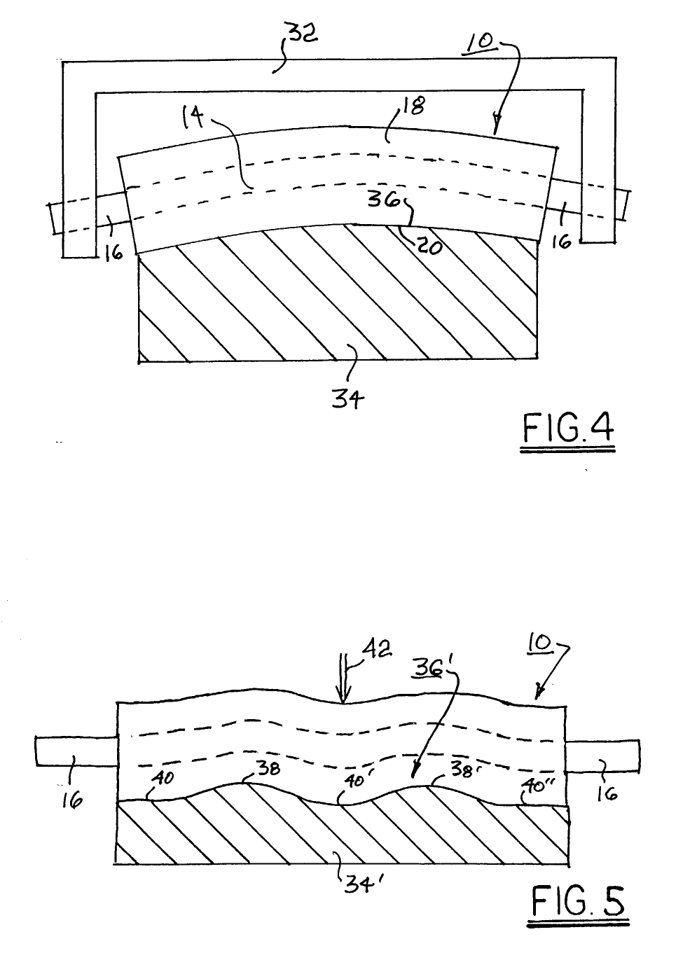

FIG. 4 is a cross-sectional view of a flexible roller in accordance with the invention supported by a frame and flexed into full contact with a curved substrate surface to be cleaned; and

FIG. 5 is a cross-sectional view of a roller in accordance with the invention, showing the roller being urged by a backing roller or other urging means into rolling contact with a undulatingly non-planar substrate surface.

Referring to FIG. 1, a first embodiment 10 of a flexible contact cleaning roller in accordance with the invention includes an inner element 12, which may be an axially-flexible through-shaft, core, or mandrel 14 as shown, having protruding ends 16 for mounting roller 10 rotatably in a supporting and positioning frame 32 such as is shown in FIG. 4. Shaft 14 has an axis of rotation 15 and may be formed of any convenient material capable of axial flexibility and of being retained in rotatable fittings, such as bearings; for example, the shaft may be formed of polymers such as nylon and metals such as steel, aluminum, or other flexible alloys. Coaxially surrounding shaft 14 and supported by shaft 14 is a cylindrical outer element 18 having at least an outer surface 20 comprising a high-tack material, for example, polyurethane, silicone rubber, or adhesive tape, for conventional contact-roller cleaning of particles from a surface as is well-known in the art. Such cleaning means is well known and need not be elaborated here further. Outer element 18 may be cast onto inner element 12 or may be formed separately, with element 12 being inserted into element 18 in a subsequent step.

Referring to FIGS. 2 and 3, second and third embodiments 10′,10″ in accordance with the invention may be provided as a monolithic axially-flexible cylindrical roller element 18′ having no through-shaft inner element. Element 18′ may comprise material of high-tack throughout or may be formed of other flexible supportive material with only a high-tack surface layer 20′ disposed concentrically thereupon, as desired.

Embodiment 10′ includes an adaptive holder 22 having a cup-shaped portion 24 for receiving and retaining an end of roller 18′ and a shaft portion 26 for rotatably mounting roller 18′ to a frame (not shown).

Embodiment 10″ includes an adaptive stub shaft 28 disposed in an axial well 30 in roller element 18′, either by insert molding or by direct insertion of stub shaft 28 into a well 30 previously molded into element 18′, shaft 28 providing means for rotatably mounting roller 18′ to a frame (not shown).

Referring to FIG. 4, a flexible contact cleaning roller, shown as 10 but equally capable of being 10′ or 10″, is rotatably retained at opposite ends in a frame 32. Such rotatable retention may take any of various well-known forms as desired, including fixed bearings, pivotable bearings, spherically mounted bearings, bushings, journals, and the like, and need not be elaborated further here. A substrate 34 having a non-planar surface 36 requiring cleaning by high-tack surface 20 of roller 10 is disposed in relationship to frame 32 such that roller 10 is axially flexed into contact with surface 36 over the entire length thereof. Thus, in operation, when frame 32 and substrate 34 are translated relative to each other in a direction perpendicular to the page, inner element 14 and outer element 18 remain flexed and in contact with surface 36 while roller 10 rolls along surface 36.

Referring to FIG. 5, other types of non-planar surfaces may be cleaned by a flexible contact cleaning roller in accordance with the invention. Surface 36′ has a plurality of relative peaks 38,38′ and valleys 40,40′,40″ not cleanable by prior art inflexible contact cleaning rollers. Roller 10 is disposed into relationship with substrate 34′ such that roller 10 makes continuous contact with surface 36′ from peak 38 through valley 40 and from peak 38′ through valley 40″. Further contact between peaks 38,38′ through valley 40′ may be provided by one or more narrow backing rollers, shown schematically as arrow 42, disposed opposite to valley 40′ and urging roller 10 into contact therewith. Other such backing and urging means as may occur to one skilled in the art should be understood as being within the scope of the invention.

From the foregoing description, it will be apparent that there has been provided an improved contact cleaning roller for cleaning planar and non-planar substrate surfaces, wherein an axially-flexible contact cleaning roller having a high-tack surface is capable of making cleaning contact with all portions of a non-planar substrate surface. Variations and modifications of the herein described flexible contact cleaning roller, in accordance with the invention, will undoubtedly suggest themselves to those skilled in this art. Accordingly, the foregoing description should be taken as illustrative and not in a limiting sense.

What is claimed is:

1. A contact cleaning roller having a tacky surface for removing particles from a substrate surface, comprising a cylindrical roller element which is axially flexible.

2. A contact cleaning roller in accordance with claim 1 wherein said roller element comprises an inner shaft element and an outer sleeve element.

3. A contact cleaning roller in accordance with claim 2 wherein said inner shaft element includes a material selected from the group consisting of plastic polymers, metals, and combinations thereof.

4. A contact cleaning roller in accordance with claim 2 wherein said outer sleeve element includes a material selected from the group consisting of polyurethane, silicone rubber, and adhesive tape.

5. A contact cleaning roller in accordance with claim 1 wherein said element is monolithic.

6. A contact cleaning roller in accordance with claim 1 further comprising adaptive means at each end of said cylindrical roller element for rotatably mounting said roller.

7. A contact cleaning roller in accordance with claim 1 further comprising a frame for supporting said roller at each end of said roller.

8. A contact cleaning roller in accordance with claim 1 further comprising backing means disposed in contact with said contact cleaning roller and opposite said substrate surface for urging said contact cleaning roller into contact with said substrate surface.

9. A contact cleaning roller in accordance with claim 8 wherein said backing means is a backing roller.
